(19) United States
(12) Patent Application Publication
(10) Pub. No.: US 2024/0399290 A1
(43) Pub. Date: Dec. 5, 2024

(54) Gas Capture System Comprising a Heat Pump Using a Liquid Sorbent With Combined Temperature and Pressure Swings

(71) Applicant: SINTEF TTO AS, Torgarden (NO)

(72) Inventors: Abdelghafour Zaabout, Trondheim (NO); Schalk Cloete, Trondheim (NO); Chaitanya Dhoke, Trondheim (NO); Hanne Kvamsdal, Trondheim (NO)

(21) Appl. No.: 18/698,104

(22) PCT Filed: Oct. 3, 2022
(86) PCT No.: PCT/EP2022/077443

§ 371 Date: Apr. 3, 2024

(30) Foreign Application Priority Data
Oct. 4, 2021 (GB) 2114158.5

(51) Int. Cl. B01D 53/14; B01D 53/18; B01D 53/34; B01D 53/52; B01D 53/62; B01D 53/78; B01D 53/96

(52) U.S. Cl. CPC B01D 53/1425; B01D 53/1412; B01D 53/1468; B01D 53/1475; B01D 53/1493; B01D 53/18; B01D 53/343; B01D 53/346; B01D 53/52; B01D 53/62; B01D 53/78; B01D 53/96; B01D 2252/20405; B01D 2252/20421; B01D 2252/20484; B01D 2257/304; B01D 2257/504; B01D 2258/0283

(57) ABSTRACT

Disclosed herein is a gas capture system comprising: a first reactor system arranged so that, in the first reactor system, at least some gas in a gas stream that is received by the gas capture system is captured by a sorbent that is arranged to flow through the first reactor system; a second reactor system arranged to regenerate the sorbent so that the sorbent releases at least some of the gas captured in the first reactor system, wherein the sorbent is arranged to flow through the second reactor system and the second reactor system is arranged to output a gas flow that comprises the released gas; a first sorbent transfer system arranged between a sorbent outlet of the first reactor system and a sorbent inlet of the second reactor system; a second sorbent transfer system arranged between a sorbent outlet of the second reactor system and a sorbent inlet of the first reactor system; and a heat pump system comprising a heat pump arranged to circulate a flow of working fluid, wherein the heat pump system is arranged to extract heat from the first reactor system and/or the gas flow output from the second reactor system; wherein: the sorbent is a liquid; the second reactor system comprises a pump arranged to reduce the pressure in the second reactor system so that the pressure in the second reactor system when regenerating sorbent may be lower than the pressure in the first reactor system during gas capture by the sorbent; and the first reactor system, first sorbent transfer system, second reactor system and second sorbent transfer system are all arranged so that they provide a sorbent flow path that recirculates the sorbent between the first reactor system and the second reactor system.

### FIELD

The present disclosure relates to a gas capture system. A gas capture system is disclosed in which gas is captured by a liquid sorbent. The sorbent is re-circulated between a first reactor system and a second reactor system. In the first reactor system, the sorbent captures a gas in a gas stream in an exothermic process. In the second reactor system, the sorbent is regenerated and the captured gas is released in an endothermic process. The second gas capture system may be operated at a lower pressure than the first gas capture system. A number of different configurations of heat pump integration may also be used within the gas capture system as an efficient means for electrification of the system.

### BACKGROUND

There is a lot of environmental pressure to reduce the emissions of carbon dioxide gas into the atmosphere. A known technology for greatly reducing the carbon dioxide released into the atmosphere is carbon capture and storage, CCS. A post-combustion carbon dioxide capture, PCCC, system may remove carbon dioxide from a flue gas generated by carbon, or hydrocarbon, combustion prior to the flue gas being released into the atmosphere. A PCCC system may be retrofitted to an existing flue gas source, such as a fossil fuel-fired power plant or combustion engine, in order for CCS to be implemented.

PCCC systems may more generally be used to remove carbon dioxide from any type of gas. In particular, a PCCC may be used to remove carbon dioxide from a gas produced by heating a raw material (that CO₂ may be a component of), such as the gasses produced in cement, phosphate rock and magnesium oxide production processes.

In a CCS system, a sorbent is used to capture, e.g. adsorb/absorb, carbon dioxide from a gas. The used sorbent is then regenerated in a process that releases the captured carbon dioxide in a contained environment.

There is a general need to improve known CCS systems to further reduce costs. More generally, there is a need to improve gas capture systems across a plurality of applications, including the capture of gases other than carbon dioxide.

### SUMMARY

Embodiments of the invention are set out in the appended independent claims. Optional features are set out in the dependent claims.

### LIST OF FIGURES

FIG. 1 shows a gas capture system according to a first embodiment;

FIG. 2 shows a gas capture system according to a second embodiment; and

FIG. 3 shows a gas capture system according to a third embodiment.

### DESCRIPTION

Embodiments of the invention provide a new gas capture system that solves one or more problems with known gas capture systems.

Embodiments include techniques for carbon dioxide capture by a gas capture system, such as a PCCC system. The gas capture system may be retrofitted to an existing fossil fuel-fired power plant, combustion engine, or any other sources of gas. Alternatively, the gas capture system may be integrated into the design of a new fossil fuel-fired power plant, combustion engine, or any other sources of gas.

According to particularly preferred embodiments, a new design of gas capture system is provided that uses a liquid sorbent. The liquid sorbent may be referred to as a solvent. The liquid sorbent may be selected from the known families: i) chemisorption (e.g., amine-based, ammonia-based, salt solutions, non-aqueous); ii) physisorption based (e.g., Glycol-, Carbonate-, methanol- and Glycerol-based); iii) hybrid phys-chemical solvents such as Ionic Liquids; iv) a mixture of these families in i) to iii).

The liquid sorbent may comprise any of the sorbents disclosed in T. N. Borhani and M. Wang (2019). “Role of solvents in CO₂ capture processes: The review of selection and design methods.” Renewable and Sustainable Energy Reviews 114: 109299; and M. Lail, J. Tanthana and L. Coleman (2014). “Non-Aqueous Solvent (NAS) CO2 Capture Process.” Energy Procedia 63: 580-594.

The gas capture system comprises a first reactor system in which carbon dioxide gas in a gas mixture is captured, i.e. adsorbed or absorbed. The first reactor system may be referred to as an absorber, or carbonator. The gas capture system also comprises a second reactor system in which the carbon dioxide gas that was captured by the sorbent is released. The second reactor system may be referred to as a desorber, or regenerator, because it regenerates the sorbent. The liquid sorbent is circulated around the system between the gas capture process in the absorber and a captured gas release process in the desorber.

The gas capture and regeneration processes within the overall system may be based on both a pressure swing and a temperature swing. That is to say, there may be a substantial pressure difference between the gas capture and regeneration processes of the sorbent. There may additionally, or alternatively, be a substantial temperature difference between the gas capture and regeneration processes of the sorbent. The gas capture and regeneration processes within the system may alternatively, or additionally, be based on a partial pressure swing using steam.

The recirculation of the liquid sorbent around the system allows the gas capture system to be operated substantially continuously.

The use of a pressure swing, and/or a partial pressure swing provided by steam, reduces the sorbent regeneration temperature. The use of a temperature swing in addition to a pressure swing allows the operating conditions to be adjusted so as to achieve a balance between the effectiveness of the gas capture process and the energy cost of operating the gas capture system. This can improve the overall efficiency of the gas capture system. The operation of the gas capture system can also be flexibly adjusted according to user requirements.

Embodiments are described in detail below with reference to a CCS system. However, it should be noted that embodiments include both the capture of other gases as well as other applications. For example, embodiments include the capture of gasses in addition, or as an alternative, to carbon dioxide, such as one or more of hydrogen sulphide, SOx (e.g. sulphur dioxide), hydrogen and NOx (e.g. nitrogen dioxide). More generally, embodiments include the capture of any type of substance for which the reaction between the substance and the sorbent is exothermic and the regeneration of the sorbent is endothermic.

Embodiments are also in no way limited to PCCC in fossil fuel-fired power plants or combustion engines. In particular, the cleaned gas can be generated by other processes than combustion (i.e. the cleaned gas does not need to be a flue gas). Embodiments include cleaning gasses in industries such as the power generation industry, metal production industry, cement production industry, fertilizer industry, petrochemical industry, biofuel production and mineral processing industry. In particular, embodiments can be used to clean gasses from cement production processes, blast furnace processes, steel production processes and reforming processes (e.g. for hydrogen production). For example, embodiments may include hydrogen sulphide capture from sour gas.

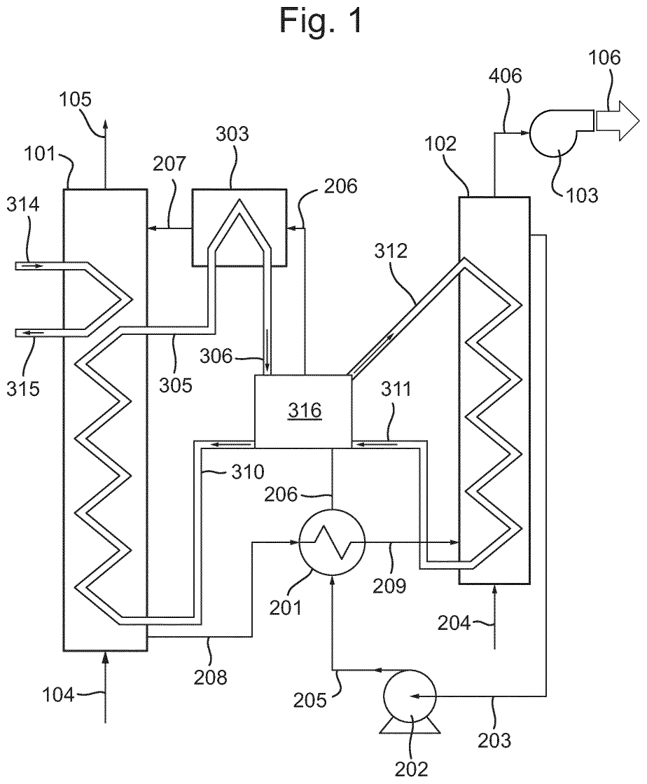

FIG. 1 shows a gas capture system according to a first embodiment.

The gas capture system comprises a first reactor system 101, a second reactor system 102, a first sorbent transfer system and a second sorbent transfer system. The first sorbent transfer system is arranged between a sorbent outlet of the first reactor system 101 and a sorbent inlet of the second reactor system. The second sorbent transfer system is arranged between a sorbent outlet of the second reactor system 102 and a sorbent inlet of the first reactor system 101.

The first reactor system 101 comprises a gas inlet 104 for receiving a gas stream, a gas outlet 105 for outputting, i.e. releasing, the gas stream, a sorbent inlet for receiving a flow of sorbent and a sorbent outlet for outputting, i.e. releasing, the flow of sorbent. The first reactor system 101 may be substantially elongate with a tubular housing. The gas inlet 104 and sorbent outlet may be arranged at a first end of the first reactor system 101. The gas outlet 105 and sorbent inlet may be arranged at a second end of the first reactor system 101. The second end may be at an opposite end of the first reactor system 101 to the first end. The first reactor system 101 may comprise at least one reaction region arranged within the housing and between the opposite ends of the first reactor system 101. In a preferred implementation, the longitudinal axis of the first reactor system is substantially vertical. The second end of the first reactor system, that comprises the gas outlet 105 and sorbent inlet, may be positioned vertically above the first end of the first reactor system, that comprises the gas inlet 104 and sorbent outlet.

The first reactor system 101 may comprise heating tubes, cooling tubes, structures, packing, baffle plates and/or beads (for slowing/controlling the flow of sorbent), as well as any other components required to establish and maintain appropriate conditions (such as to ensure proper contacting area) in the first reactor system 101 for a reaction to occur between the liquid sorbent and a gas in the gas stream. In particular, in the first reactor system 101 cooling tubes/pipes may extend through the reaction region and indirectly cool the sorbent and gas therein. The first reactor system 101 may also comprise components, such as fans and channels, for ensuring an appropriate flow of the sorbent and the gas stream through the first reactor system 101.

The cooling tubes and/or structures may comprise a hollow 3D structure/packing where a working fluid is passed through for heat addition or removal. The structure/packing could be stationary or rotating. The first reactor system may also include a membrane for selectively removing one or more of the gasses therein. The first reactor system may be according to the disclosure in Wang, M., A. S. Joel, C. Ramshaw, D. Eimer and N. M. Musa (2015). “Process intensification for post-combustion CO2 capture with chemical absorption: A critical review.” Applied Energy 158: 275-291; and/or Bolton, S., A. Kasturi, S. Palko, C. Lai, L. Love, J. Parks, S. Xin and C. Tsouris (2019). “3D printed structures for optimized carbon capture technology in packed bed columns.” Separation Science and Technology 54(13): 2047-2058.

The first reactor system 101 may be a counter current reactor. The gas may first flow substantially upwards through a reaction region and contact a downwards flow of sorbent. The reaction region may also comprise heat transfer surfaces of a heat exchanger. The reaction in the reaction region may be exothermic and the heat transfer surfaces cool the gas and sorbent. Preferably, the operating temperature within the reaction region of the first reactor system 101 is maintained at a substantially constant temperature (i.e. isothermal conditions may be maintained).

The first sorbent transfer system is arranged between a sorbent outlet of the first reactor system 101 and a sorbent inlet of the second reactor system 102. The first sorbent transfer system comprises a first sorbent output conduit 208, a heat exchanger 201, and second sorbent input conduit 209. The first sorbent output conduit 208 is arranged to receive a flow of sorbent from the first reactor system 101. The second sorbent input conduit 209 is arranged to provide a flow of sorbent to the second reactor system 102. The heat exchanger 201 is arranged between the first sorbent output conduit 208 and the second sorbent input conduit 209. Sorbent may therefore flow from the first sorbent output conduit 208, through the heat exchanger 201 and to the second sorbent input conduit 209.

The first sorbent transfer system is arranged so that sorbent may pass from the first reactor system 101 to the second reactor system 102 without substantial gas transfer occurring between the first reactor system 101 and the second reactor system 102. There is therefore substantially no gas flow between the first reactor system 101 and the second reactor system 102, and vice-versa.

The second reactor system 102 comprises a sorbent inlet, a regeneration region and a sorbent outlet. The second reactor system 102 may be substantially elongated with a tubular housing. The sorbent inlet and sorbent outlet may be at opposite ends of the second reactor system 102. The regeneration region may be arranged within the housing and between the sorbent inlet and sorbent outlet. The second reactor system 102 also comprises a second reactor system output conduit 406 and a gas outlet 106 arranged so that released gas from the sorbent may flow out of the regeneration region of the second reactor system 102. The gas outlet 106 may be at the same end of the second reactor system 102 as the sorbent outlet. The second reactor system 102 comprises a reactor pump 103 for reducing the pressure in the regeneration region of the second reactor system 102. The reactor pump 103 may be a vacuum pump and operable to reduce the pressure in the regeneration region of the second reactor system 102 to a substantial vacuum. The reactor pump 103 may also suck gas released in the regeneration region out of the second reactor system 102. The gas released in the regeneration region may flow through the second reactor system output conduit 406 and reactor pump 103 to the gas outlet 106.

The second reactor system 102 may comprise heat exchange surfaces such as heating tubes, cooling tubes and any other components required to establish and maintain appropriate conditions in the second reactor system 102 for regeneration of the sorbent to occur. In particular, heating tubes, such as heat pipes, may extend through the regeneration region of the second reactor system 102 and indirectly heat sorbent that is moving through the regeneration region.

The second reactor system 102 may also comprise components, such as fans, pumps and channels, for ensuring an appropriate flow of the sorbent and gas through the second reactor system 102.

The second reactor system 102 is arranged vertically with the sorbent outlet arranged vertically above the sorbent inlet. Embodiments also include the second reactor system 102 being arranged vertically with the sorbent inlet arranged vertically above the sorbent outlet.

The second reactor system may comprise a steam inlet 204 so that steam may be injected into the second reactor system 102 to reduce the partial pressure of the released gas in the second reactor system 102. As explained later, the steam that is injected through the steam inlet 204 may be generated by a water based heat exchanger in the first reactor system 101. The steam that is injected through the steam inlet 204 may alternatively, or additionally, be generated by heat recovered from anywhere in the gas capture system, heat recovered from the source of the gas at the gas inlet 104, heat recovered from the output gasses from the gas capture system, and any output steam from the gas capture system. When the captured carbon dioxide is to be compressed for transport and storage, the steam may additionally, or alternatively, be generated from the compressor process required to compress the carbon dioxide.

The second sorbent transfer system is arranged between a sorbent outlet of the second reactor system 102 and a sorbent inlet of the first reactor system 101. The second sorbent transfer system comprises a second sorbent output conduit 203, a sorbent pump 202, a sorbent pump output conduit 205, the heat exchanger 201, a heat exchanger output conduit 206, a cooler 303 and a first sorbent input conduit 207.

The second sorbent output conduit 203 is arranged to receive a flow of sorbent from the second reactor system 102. The second sorbent output conduit 203 is arranged to provide a flow of sorbent to the sorbent pump 202. The sorbent pump 202 is arranged so that sorbent may flow through it and into the sorbent pump output conduit 205. The sorbent pump output conduit 205 is arranged to provide a flow of sorbent to the heat exchanger 201. The heat exchanger 201 is arranged so that sorbent may flow through it and into the heat exchanger output conduit 206. The heat exchanger output conduit 206 is arranged to provide a flow of sorbent to the cooler 303. The cooler 303 is arranged so that sorbent may flow through it and into the first sorbent input conduit 207.

The sorbent pump 202 is arranged to control the flowrate of sorbent. The sorbent pump 202 may therefore circulate the sorbent in between the first reactor system 101, the first sorbent transfer system, the second reactor system 102 and the second sorbent transfer system. The sorbent pump also increases the pressure of the solvent coming from the second reactor system 102.

The second sorbent transfer system is arranged so that sorbent may pass from the second reactor system 102 to the first reactor system 101 without substantial gas transfer occurring between the second reactor system 102 and the first reactor system 101. There is therefore substantially no gas flow between the second reactor system 102 and the first reactor system 101, and vice-versa.

Under operation of the gas capture system, the first reactor system 101 receives a gas stream at the gas inlet 104. The gas stream may be a gas mixture that comprises a gas that may be captured by the sorbent. The gas stream flows from the gas inlet 104, through the reaction region and out through the gas outlet 105. The gas stream may flow substantially vertically upwards through the first reactor system 101.

The first reactor system 101 also receives a flow of sorbent from the first sorbent input conduit 207. The sorbent flows through the reaction region and into the first sorbent output conduit 208. The sorbent may flow substantially vertically downwards through the first reactor system 101. The sorbent may be a sorbent of at least one of the gasses in the gas mixture. The sorbent is a liquid.

The sorbent and gas stream may be in a substantial counter flow through the first reactor system 101. The sorbent contacts the gas stream in the reaction region and reacts to capture at least some of the gas in the gas stream. The sorbent may adsorb and/or absorb gas so that there is mass transfer between a gas in the gas stream and the sorbent. The gas stream at the gas outlet 105 may therefore comprise a lower concentration of the captured gas by the sorbent than the gas stream at the gas inlet 104.

The first reactor system 101 may comprise either a single reactor or a plurality of reactors. For example, the number of reactors comprised by the first reactor system 101 may be between 2 and 10. Each reactor may comprise a gas inlet for receiving the gas stream, a gas outlet for outputting, i.e. releasing, the gas stream, a sorbent inlet for receiving the sorbent and a sorbent outlet for outputting, i.e. releasing, the sorbent. Each reactor may be one of the above-described counter current reactors. The counter current reactors may all be arranged in series with each other, or in a series/parallel configuration. A heat exchanger may be provided in each of the counter current reactors so that heat transfer surfaces in each reactor cool the gas and sorbent therein.

An advantage of the first reactor system 101 comprising a plurality of reactors is that it may be easier to maintain the desired reaction conditions in a plurality of small reactors than in a single large reactor, however, one larger reactor may be less expensive due to economy of scale.

The gas stream that flows out of the gas outlet 105 may be released directly into the atmosphere. Alternatively, further processes may be performed on the gas stream. For example, the gas stream may be supplied to another gas capture process for capturing another gas component in the gas stream and/or for further increasing the capture amount of the former captured gas component. The gas stream may additionally, or alternatively, be passed through a heat exchanger for capturing some of its heat before it is released into the atmosphere. The heat capture may also reduce the release of volatile sorbents into the atmosphere.

The sorbent may flow out of the sorbent outlet of the first reactor system 101 and into the first sorbent transfer system. There may be one or more valves for controlling the flow of sorbent out of the first reactor system 101.

The sorbent flows from the second sorbent input conduit 209 into the regeneration region of the second reactor system 102. The reactor pump 103 may reduce the operational pressure in the regeneration region to an at least partial, and optionally substantial, vacuum. The sorbent may be heated in the sorbent regeneration region. The temperature and pressure conditions in the regeneration region regenerate the sorbent so that the sorbent releases at least some of the gas that was captured by the sorbent in the first reactor system 101. The gas that is released by the sorbent may flow out of the second reactor system 102 through the gas outlet 106. The sorbent may flow through the sorbent outlet and into the second sorbent transfer system.

In the second reactor system, the liquid sorbent may contact heat transfer surfaces of a heat exchanger. The heat transfer surfaces may heat the sorbent so as to maintain a substantially constant reaction temperature even though the regeneration of the sorbent is an endothermic process. The liquid sorbent may be provided to the bottom of the second reactor system 102 and arranged to flow upwards through the second reactor system 102. Alternatively, the liquid sorbent may be provided to the top of the second reactor system 102 and arranged to flow downwards through the second reactor system 102.

As described above, there may be a heat exchanger 201 that is in the sorbent flow paths of both the first sorbent transfer system and the second sorbent transfer system. The sorbent flowing out of the second reactor system 102 may be at a higher temperature than the sorbent that flows out of the first reactor system 101. The heat exchanger 201 may transfer some of the heat from the sorbent flow path in the second sorbent transfer system to the sorbent flow path in the first sorbent transfer system. Advantageously, this may both heat the sorbent before it is supplied to the second reactor system 102 and cool the sorbent before it is supplied to the first reactor system 101.

Accordingly, embodiments provide a gas capture system with a gas inlet 104 for receiving a gas stream, a gas outlet 105 for outputting a cleaned gas stream and a separate gas outlet 106 for outputting captured gas from the received gas stream. Liquid sorbent may be recirculated around the components of the gas capture system. When the sorbent is in the first reactor system 101, gas is captured by the sorbent and when the sorbent is in the second reactor system 102 the captured gas is released by the sorbent. The received gas stream by the gas capture system is therefore cleaned by the sorbent.

The regeneration of the sorbent in the second reactor system 102 may occur at a higher temperature than the gas capture by the sorbent in the first reactor system 101. The regeneration of the sorbent may therefore be performed by a temperature swing.

The regeneration of the sorbent in the second reactor system 102 may occur at a lower pressure than the gas capture by the sorbent in the first reactor system 101. The use and regeneration of the sorbent may therefore be performed by a pressure swing.

Embodiments include the use and regeneration of the sorbent being performed by a combined temperature swing and pressure swing.

The gas capture system may comprise a controller for controlling the operating conditions of the first reactor system 101 and the second reactor system 102.

Embodiments include automatically adjusting the operating conditions of the first reactor system 101 and the second reactor system 102 so that the operating conditions are the most appropriate for the current application. In particular, the operating temperatures in the first reactor system 101 and the second reactor system 102, as well as the operating pressures in the first reactor system 101 and the second reactor system 102, may be adjusted to achieve a desired amount of gas capture at a low energy cost.

Depending on the application and user requirements, the most appropriate operating conditions for the gas capture system may be, for example, those that achieve the maximum amount of gas capture with the lowest energy requirement. The most appropriate operating conditions for the gas capture system may alternatively be those that achieve a desired amount of gas capture with a low energy requirement. The desired amount of gas capture may not be the maximum achievable amount of gas capture. The desired amount of gas capture may be determined in dependence on the financial cost, in CAPEX and/or OPEX, of the gas capture process.

The operating conditions for achieving the maximum, or desired, amount of gas capture may vary and depend on the content, temperature, pressure and/or other properties of the gas stream that is received by the gas capture system. The gas capture system according to embodiments may be automatically controlled so that the operating conditions are automatically adjusted as required for achieving the desired amount of gas capture and energy requirements. In particular, the operating temperatures in the first reactor system 101 and the second reactor system 102, as well as the operating pressures in the first reactor system 101 and the second reactor system 102, may be adjusted to achieve a desired amount of gas capture at the lowest energy cost.

As described in more detail later, embodiments include using a heat pump system to transfer heat from the first reactor system 101 to the second reactor system 102. Embodiments include selecting and operating the heat pump system so as to improve the overall performance of the gas capture system. For example, the use of a heat pump system may reduce the overall energy requirements, CAPEX and/or OPEX.

The gas capture reaction in the first reactor system 101 may be exothermic. The first reactor system 101 may comprise one or more cooling tubes/plates for maintaining a desired reaction temperature in the first reactor system 101. The cooling tubes/plates may extend through the reaction region of the first reactor system 101 and be in direct thermal contact with the gas stream and sorbent.

The sorbent regeneration reaction in the second reactor system 102 may be endothermic. The second reactor system 102 may comprise one or more heating tubes/plates for maintaining a desired reaction temperature in the second reactor system 102. The heating tubes/plates may extend through the regeneration region of the second reactor system 102 and be in direct thermal contact with the sorbent, and gas released by the sorbent.

The first reactor system 101 may comprise a water based heat exchanger. The water based heat exchanger may comprise a fluid inlet 314 and fluid outlet 315 as well as a fluid conduit arranged between the fluid inlet 314 and fluid outlet 315. The fluid conduit may be provided in at least one reaction region of the first reactor system 101. When the system is operated, fluid that flows through the fluid conduit may be heated. For example, water may flow through the fluid inlet 314 and into the fluid conduit. The water may be heated in the fluid conduit so that steam flows out of the fluid outlet 315. Advantageously, this takes heat out of the first reactor system 101 and helps to maintain the reaction temperature therein. Some, or all, of the steam may also be supplied to the steam inlet 204 of the second reactor system 102. The injection of steam into the second reactor system 102 reduces the partial pressure of the released gas, e.g. carbon dioxide, in the second reactor system 102 and thereby increases the release of the captured gas by the sorbent.

The gas capture system may comprise substantially independent systems for providing cooling to the first reactor system 101 and heating to the second reactor system 102. Alternatively, or additionally, the gas capture system may comprise a heat pump system, as shown in FIG. 1. The heat pump system may be arranged to use a working fluid to transfer some of the heat from the first reactor system 101 to the second reactor system 102.

The heat pump system may comprise a heat pump 316 with a first side and a second side. The first side of the heat pump may comprise a compressor for compressing the working fluid. The second side of the heat pump may comprise an expansion valve for expanding the working fluid. The heat pump system may further comprise a first side input conduit 306, a first side output conduit 312, a second side input conduit 311, a second side output conduit 310 and reactor-cooler conduit 305. The heat pump system may further comprise heat pipes in the first reactor system 101, the cooler 303 and the second reactor system 102.

The heat pump system may be arranged to circulate a working fluid. The working fluid may flow out of the second side of the heat pump into the second side output conduit 310. The working fluid may flow out of the second side output conduit 310 into one or more heat pipes in the first reactor system 101. The working fluid may flow out of the one or more heat pipes in the first reactor system 101 and into the reactor-cooler conduit 305. The working fluid may flow out of the reactor-cooler conduit 305 and into one or more heat pipes in the cooler 303. The working fluid may flow out of the one or more heat pipes in the cooler 303 into the first side input conduit 306. The working fluid may flow out of the first side input conduit 306 and into the first side of the heat pump 316. The working fluid may flow through a compressor in the first side of the heat pump 316 so that it is compressed in the first side of the heat pump. The working fluid may flow out of the first side of the heat pump 316 and into the first side output conduit 312. The working fluid may flow out of the first side output conduit 312 and into one or more heat pipes in the second reactor system 102. The working fluid may flow out of the one or more heat pipes in the second reactor system 102 and into the second side input conduit 311. The working fluid may flow out of the second side input conduit 311 and into the second side of the heat pump 316. The working fluid may flow through an expansion valve in the second side of the heat pump 316 so that it is expanded in the second side of the heat pump. The working fluid may then flow out of the second side of the heat pump into the second side output conduit 310 so that the working fluid is circulated around the heat pump system.

The working fluid may undergo a number of temperature and/or phase changes as it is circulated around the heat pump system. In particular, the working fluid flowing in the second side output conduit 310 may be a cool liquid. In the one or more heat pipes in the first reactor system 101, the working fluid may be heated by the reaction in the first reactor system 101. The heating of the working fluid may cause a phase change to occur in the one or more heat pipes in the first reactor system 101. Accordingly, the working fluid may evaporate so that the working fluid in the reactor-cooler conduit 305 is a cool gas. The working fluid flowing through the one or more heat pipes in the cooler 303 may be heated by the sorbent flowing through the cooler 303, and thereby cool the sorbent flowing through the cooler 303. The working fluid flowing in the first side input conduit 306 may be a cool gas (that may be at a higher temperature that the working fluid in the reactor-cooler conduit 305). In the first side of the heat pump 316, the working fluid may be compressed so that it is heated. The working fluid in the first side output conduit 312 may be a hot gas. In the one or more heat pipes in the second reactor system 102, the working fluid may be cooled by the reaction in the second reactor system 102. The cooling of the working fluid may cause a phase change to occur in the one or more heat pipes in the second reactor system 102. Accordingly, the working fluid may condense so that the working fluid in the second side input conduit 311 is a hot liquid. In the second side of the heat pump 316, the working fluid may be expanded so that it is cooled.

Accordingly, the working fluid transfers heat from the first reactor system 101 to the second reactor system 102. Advantageously, the working fluid circulated by the heat pump system may evaporate in the first reactor system 101 and condense in the second reactor system 102. Such phase change heat transfers may be highly efficient and thereby may maximise heat recovery. The phase changes may also occur at a substantially constant temperature and this helps to maintain substantially constant reaction conditions in the first reactor system 101 and the second reactor system 102. Phase change heat transfers may be performed with heat exchangers that have a small surface area and this both aids the implementation of the heat exchangers and reduces costs. The use of a liquid sorbent, together with the phase change in the heat pump, also ensures a very high heat transfer, that may be about 1000 W/m².K

The provision of a pressure swing between the first reactor system 101 and the second reactor system 102 reduces the temperature difference between the temperature required for gas capture by the sorbent and the temperature required for regeneration of the sorbent. This improves the efficiency of the heat pump system. The heat pump system supplies heat generated in the exothermic gas capture process to the endothermic sorbent regeneration process. The heat pump system may provide an energy saving that reduces the overall energy cost of operating the gas capture system.

The gas capture system according to embodiments may be operated by an electrical power supply only. The electrical power may be required for establishing a vacuum, or partial vacuum, in the second reactor system 102. The electrical power may also be required for operating a compressor in the heat pump system 107, as well as operating fans, pumps, heaters and any other components that the gas capture system may comprise. The gas capture system may therefore be particularly suited to retrofitting to an existing source of a gas stream, such as a flue gas, because it does not require heat integration with the source of the gas stream.

One application of the gas capture system of embodiment is as a PCCC system that has been retrofitted to a source of flue gas, such as a fossil fuel-fired power plant or combustion engine.

The received gas stream at the gas inlet 104 may be a carbonaceous gas, such as a flue gas that comprises carbon dioxide. The sorbent may be a sorbent of carbon dioxide. In the first reactor system 101 at least some of the carbon dioxide in the flue gas may be captured by the sorbent. The first reactor system 101 may therefore be a carbonator. The second reactor system 102 may be a sorbent regenerator. The gas output from the gas outlet 106 of the second reactor system 102 may be substantially pure carbon dioxide. The carbon dioxide may be stored or used in industrial processes, according to known techniques. For example, the carbon dioxide may be input into a compression and liquefaction plant so that the carbon dioxide is not released into the atmosphere.

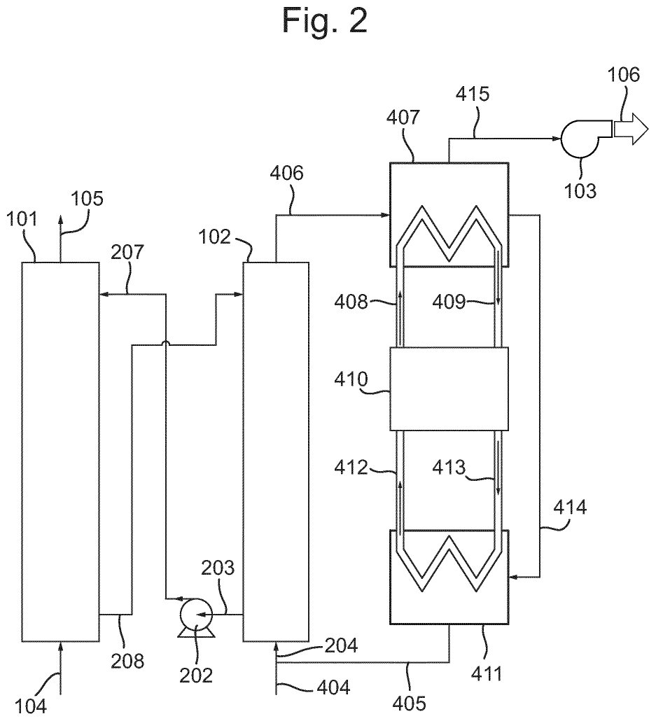

A second embodiment is described below with reference to FIG. 2. The second embodiment also provides a gas capture system that captures a gas by circulating a liquid sorbent. The gas capture system of the second embodiment may be used for the same, or similar, applications to those already described for the first embodiment. The operating conditions of the gas capture system of the second embodiment may be determined in dependence on the same, or similar, considerations to those already described for the first embodiment.

The second embodiment may comprise a number of the earlier described components of the first embodiment. In particular, the first reactor system 101 and second reactor system 102 of the second embodiment may be the same as, or similar to, the first reactor system 101 and second reactor system 102 of the first embodiment. In the second embodiment, the first reactor system 101 may also receive a gas mixture, at a gas inlet 104, and capture a gas within the gas mixture. The gas mixture may be a flue gas and the captured gas may be carbon dioxide.

The gas capture system of the second embodiment comprises a first reactor system 101, a second reactor system 102, a first sorbent transfer system and a second sorbent transfer system. The first sorbent transfer system is arranged between a sorbent outlet of the first reactor system 101 and a sorbent inlet of the second reactor system. The second sorbent transfer system is arranged between a sorbent outlet of the second reactor system 102 and a sorbent inlet of the first reactor system 101.

The first reactor system 101 comprises a gas inlet 104 for receiving a gas stream, a gas outlet 105 for outputting the gas stream, a sorbent inlet for receiving a flow of sorbent and a sorbent outlet for outputting the flow of sorbent. The first reactor system 101 may be substantially elongate with a tubular housing. The gas inlet 104 and sorbent outlet may be arranged at a first end of the first reactor system 101. The gas outlet 105 and sorbent inlet may be arranged at a second end of the first reactor system 101. The second end may be at an opposite end of the first reactor system 101 to the first end. The first reactor system 101 may comprise at least one reaction region arranged within the housing and between the opposite ends of the first reactor system 101. In a preferred implementation, the longitudinal axis of the first reactor system is substantially vertical. The second end of the first reactor system, that comprises the gas outlet 105 and sorbent inlet, may be positioned vertically above the first end of the first reactor system, that comprises the gas inlet 104 and sorbent outlet.

The first reactor system 101 may comprise heating tubes, cooling tubes, structures, packing, baffle plates and/or beads (for slowing/controlling the flow of sorbent), as well as any other components required to establish and maintain appropriate conditions in the first reactor system 101 for a reaction to occur between the liquid sorbent and a gas in the gas stream. In particular, in the first reactor system 101 cooling tubes/pipes may extend through the reaction region and indirectly cool the sorbent and gas therein. The first reactor system 101 may also comprise components, such as fans and channels, for ensuring an appropriate flow of the sorbent and the gas stream through the first reactor system 101.

The first sorbent transfer system is arranged between a sorbent outlet of the first reactor system 101 and a sorbent inlet of the second reactor system 102. The first sorbent transfer system may comprise first sorbent output conduit 208 arranged to support a flow of sorbent between the first reactor system 101 and the second reactor system 102.

The second sorbent transfer system is arranged between a sorbent outlet of the second reactor system 102 and a sorbent inlet of the first reactor system 101. The second sorbent transfer system may comprise a second sorbent output conduit 203, a sorbent pump 202 and a first sorbent input conduit 207.

The sorbent pump 202 is arranged to control the flowrate of sorbent. The sorbent pump 202 may therefore circulate the sorbent in between the first reactor system 101, the first sorbent transfer system, the second reactor system 102 and the second sorbent transfer system.

The second reactor system 102 comprises a sorbent inlet, a regeneration region and a sorbent outlet. The second reactor system 102 may be substantially elongate with a tubular housing. The sorbent inlet and sorbent outlet may be at opposite ends of the second reactor system 102. The regeneration region may be arranged within the housing and between the sorbent inlet and sorbent outlet. The second reactor system 102 also comprises a gas outlet 106 arranged so that released gas from the sorbent may flow out of the regeneration region of the second reactor system 102. The gas outlet 106 may be at the same end of the second reactor system 102 as the sorbent outlet. The second reactor system 102 comprises a reactor pump 103 for reducing the pressure in the regeneration region of the second reactor system 102. The reactor pump 103 may be a vacuum pump and operable to reduce the pressure in the regeneration region of the second reactor system 102 to a substantial vacuum. The reactor pump 103 also sucks gas released in the regeneration region out of the second reactor system 102.

The second reactor system 102 may comprise heating tubes, cooling tubes and any other components required to establish and maintain appropriate conditions in the second reactor system 102 for regeneration of the sorbent to occur. In particular, heating tubes, such as heat pipes, may extend through the regeneration region of the second reactor system 102 and indirectly heat sorbent that is moving through the regeneration region.

The second reactor system 102 may also comprise components, such as fans, pumps and channels, for ensuring an appropriate flow of the sorbent and gas through the second reactor system 102.

The second reactor system 102 may be arranged vertically with the sorbent inlet arranged vertically above the sorbent outlet. Embodiments also include the second reactor system 102 being arranged vertically with the sorbent outlet arranged vertically above the sorbent inlet.

The second reactor system may comprise a steam inlet 204. As described for the first embodiment, steam may be injected into the steam inlet 204 to reduce the partial pressure of the released gas in the second reactor system 102.

The second embodiment may differ from the first embodiment by there being no heat exchanger between the first sorbent transfer system and the second sorbent transfer system. The second embodiment may also differ from the first embodiment by the second sorbent transfer system not comprising a cooler 303 for cooling the sorbent.

The second embodiment may also differ from the first embodiment by comprising a heat exchanger system, that is a heat pump system, for recovering latent heat from a mixture of steam and captured gas in the second reactor system output conduit 406. The steam may be condensed to recover the latent heat. Given that the pressure is low, the condensation may occur at a low temperature, such as 40° C. to 90° C., or 50° C. to 70° C.

The heat exchanger system may comprise a first heat exchanger 407, a heat pump 410 and a second heat exchanger 411. At least the first heat exchanger 407 of the heat exchanger system may be comprised by the second reactor system 102.

The heat pump 410 may comprise a first side and a second side. The first side of the heat pump 410 may comprise a compressor so that, when the working fluid flows through the first side of the heat pump 410, it may be compressed within the heat pump. The second side of the heat pump 410 may comprise an expansion valve so that, when the working fluid flows through the second side of the heat pump 410, it may be expanded within the heat pump 410.

A working fluid may be circulated between the first heat exchanger 407, the heat pump 410 and the second heat exchanger 411. In particular, the working fluid may flow out of the second side of the heat pump 410 into an input conduit 408 of the first heat exchanger 407. The working fluid may then flow through the first heat exchanger 407. The working fluid may then flow out of the first heat exchanger 407 into an output conduit 409 of the first heat exchanger 407. The working fluid may then flow through the first side of the heat pump 410, where it is compressed, and into an input conduit 413 of the second heat exchanger 411. The working fluid may then flow through the second heat exchanger 411. The working fluid may then flow out of the second heat exchanger 411 into an output conduit 412 of the second heat exchanger 411. The working fluid may then flow back to the second side of the heat pump 410, where it is expanded.

The working fluid may be any suitable working fluid. The state of the working fluid flowing into the first heat exchanger 407 may be a cool liquid. The state of the working fluid flowing out of the first heat exchanger 407 may be a cool gas. The state of the working fluid flowing into the first side of the heat pump 410 may be a cool gas. The state of the working fluid flowing out of the first side of the heat pump 410 may be a hot gas. The state of the working fluid flowing into the second heat exchanger 411 may be a hot gas. The state of the working fluid flowing out of the second heat exchanger 411 may be a hot liquid. The state of the working fluid flowing into the second side of the heat pump 410 may be a hot liquid.

Accordingly, the working fluid may undergo phase changes in each of the heat exchangers 407, 411. This may reduce the size and improve the efficiency of the heat exchangers 407, 411. The phase changes may also occur at substantially constant temperatures.

In the first heat exchanger 407, at least some, and preferably all, of the steam in the gas mixture that is output from the second reactor system 102, i.e. the steam flowing through the second reactor system output conduit 406, may be condensed. This process recovers a substantial amount of latent heat that is transferred, by the heat pump 410, to the second heat exchanger 411 for raising steam. Advantageously, the output gas from the first heat exchanger 407 to the reactor pump 103 and gas outlet 106 may have a high concentration of the captured gas, that may be carbon dioxide.

The second heat exchanger 411 may comprise an inlet for receiving a supply of water from a water supply conduit 414. As shown in FIG. 2, the water in the water supply conduit 414 may be a supply of water that has condensed in the first heat exchanger 407. Additionally, or alternatively, the water supply may be from another source. In the second heat exchanger 411 the received water from the water supply conduit 414 may be used to cool the working fluid. In this process the water may be heated to generate steam. The second heat exchanger may comprise a steam outlet conduit 405 for providing steam to a steam inlet 204 of the second reactor system 102.

There may also be a steam supply conduit 404 that is an additional source of steam to the steam inlet 204 of the second reactor system 102. The steam in the steam supply conduit 404 may be generated from any available heat source. For example, the steam may be generated from heat in the first reactor system 101 as described for the first embodiment. The steam may additionally, or alternatively, be generated from excess heat in the system that generates the gas mixture, for example flue gas, that is received by the first reactor system 101. The steam may additionally, or alternatively, be generated from compressors when carbon dioxide is to be compressed for transport and storage.

Accordingly, during operation of the gas capture system, low pressure and low temperature steam may be supplied to the steam inlet 204 of the second reactor system 102. The steam may mix with the flow of sorbent in the second reactor system 102. The effect of the steam is to reduce the partial pressure of the gas, that may be carbon dioxide, released by the sorbent in the second reactor system 102.

Advantageously, this may increase the release of gas from the sorbent and thereby increase the amount and/or efficiency of gas capture. Another advantage is that the use of steam may reduce the level of vacuum required in the second reactor system 102. Although the second reactor system 102 would typically be operated at a different pressure than the first reactor system 101, embodiments include the second reactor system 102 being operated so that the first reactor system 101 and the second reactor system 102 are operated at the same pressure, and/or the second reactor system 102 being operated substantially at atmospheric pressure.

In the second embodiment, a heat exchanger system may remove heat from the first reactor system 101 and then release the heat to the atmosphere, instead of supplying the heat to the second reactor system 102. The second reactor system 102 may operate substantially at atmospheric pressure. There may therefore only be a temperature difference, and no pressure difference, between the reaction conditions in the first reactor system 101 and second reactor system 102.

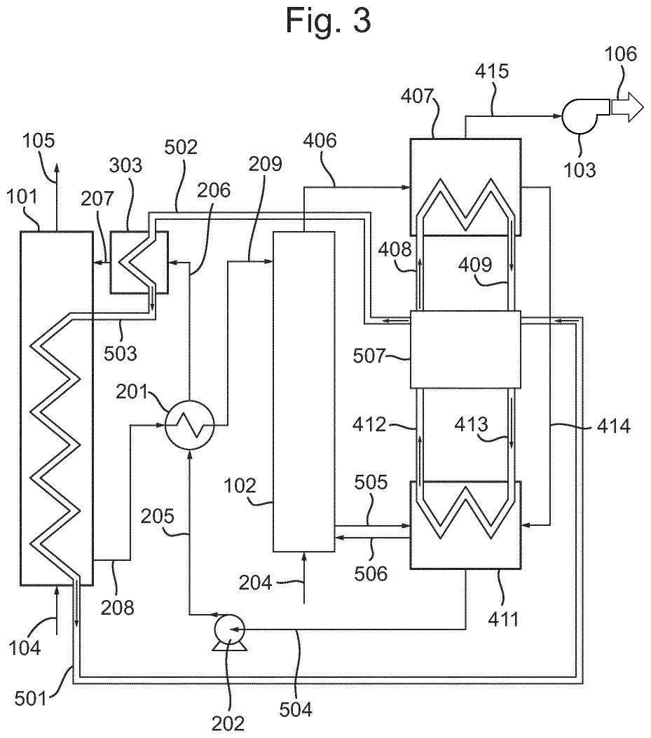

FIG. 3 shows a gas capture system according to a third embodiment.

The gas capture system of the third embodiment comprises components that may be the same as, or similar, to the earlier described components of the first and second embodiments. In the third embodiment, the first reactor system 101 may also receive a gas mixture, at a gas inlet 104, and capture a gas within the gas mixture. The gas mixture may be a flue gas and the captured gas may be carbon dioxide.

The gas capture system of the third embodiment may be used for the same, or similar, applications to those already described for the first and second embodiments. The operating conditions of the gas capture system of the third embodiment may be determined in dependence on the same, or similar, considerations to those already described for the first and second embodiments.

In the third embodiment, liquid sorbent is circulated between a first reactor system 101 and a second reactor system 102. There is a first sorbent transfer system that is arranged between a sorbent outlet of the first reactor system 101 and a sorbent inlet of the second reactor system 102. There is a second sorbent transfer system that is arranged between a sorbent outlet of the second reactor system 102 and a sorbent inlet of the first reactor system 101.

In the third embodiment, a heat pump system is arranged to recover some of the heat generated by the exothermic carbonation reaction in the first reactor system 101. Accordingly, the working fluid of the heat pump system may flow through one or more heat pipes in the first reactor system 101, as already described for the first embodiment.

In the third embodiment, there may be a cooler 303 arranged to cool the sorbent before the sorbent flows into the first reactor system 101. The working fluid of the heat pump system may flow through the cooler 303 and exchange heat with the sorbent, as already described for the first embodiment. Accordingly, the working fluid flowing through the one or more heat pipes in the cooler 303 may be heated by the sorbent flowing through the cooler 303, and thereby cool the sorbent flowing through the cooler 303.

In the third embodiment, a heat exchanger system may recover some of the latent heat from the gas output from the second reactor system 102, as already described for the second embodiment. Accordingly, the heat exchanger system may comprise a first heat exchanger 407, a heat pump 507 and a second heat exchanger 411. The heat pump 507 may be the same heat pump 507 that operates on the working fluid that flows through the first reactor system 101 and the cooler 303.

Accordingly, the third embodiment comprises some of the above-described features of both the first and second embodiments.

The third embodiment may differ from the first and second embodiments by the sorbent that flows out of the second reactor system 102 flowing through the second heat exchanger 411 in the heat exchanger system. This may transfer some of the heat from the sorbent to water that flows into the second heat exchanger 411. The type of liquid sorbent may be monoethanolamine, MEA, that is saturated with water. The water may evaporate in the second heat exchanger 411 to produce low pressure steam which may be fed back to the second reactor system 102.

As described for the first embodiment, the sorbent may then flow to the first reactor system 101, via a sorbent pump 202, the heat exchanger 201 and the cooler 303.

In the third embodiment, the first sorbent transfer system may be substantially the same as the first sorbent transfer system as described for the first embodiment.

A description of the flow of the liquid sorbent in the gas capture system of the third embodiment is provided below.

In the first reactor system 101 sorbent is contacted with the gas stream that has flowed into the first reactor system 101 through the gas inlet 104. The sorbent adsorbs/absorbs/captures a gas in the gas stream, such as carbon dioxide. The sorbent that flows out of the first reactor system into the first sorbent output conduit 208 is a cool liquid. The sorbent then flows from the first sorbent output conduit 208 into the heat exchanger 201 where the sorbent is heated by a flow of sorbent through the second sorbent transfer system. The sorbent then flows into the second sorbent input conduit 209. The sorbent then flows into the second reactor system 102. In the second reactor system 102 at least some, and preferably all, of the sorbent is regenerated so that the captured gas by the sorbent is released. In the second reactor system 102, the sorbent may be regenerated due to any of the sorbent being heated, the sorbent undergoing a pressure swing and the sorbent undergoing a steam partial pressure swing. The sorbent may either flow upwards or downwards through the second reactor system 102. The sorbent flows out of the second reactor system 102 into a conduit 505 between the second reactor system 102 and the second heat exchanger 411. In the second heat exchanger 102, the sorbent, that may be water saturated MEA, may release steam. The sorbent flows out of the second heat exchanger 102 into a conduit 504 between the second heat exchanger 102 and the sorbent pump 202. The sorbent pump 202 may control the flow rate of the sorbent and also increase the pressure of the sorbent. The sorbent flows through the sorbent pump 202 into the sorbent pump output conduit 205. The sorbent flows through the sorbent pump output conduit 205 and into the heat exchanger 201. In the heat exchanger 201, the sorbent is cooled by the flow of sorbent through the first sorbent transfer system. The sorbent then flows into the heat exchanger output conduit 206. The sorbent then flows into the cooler 303. In the cooler 303, the sorbent is cooled by a flow of the working fluid. The sorbent then flows into the first sorbent input conduit 207. The sorbent then flows back into the first reactor system 101. The sorbent therefore cyclically flows through the above-described components of the gas capture system.

A description of the flow of the working fluid in the gas capture system of the third embodiment is provided below.

The gas capture system comprises a heat pump 507 with a first side and a second side. The first side of the heat pump may comprise a compressor for compressing the working fluid. The second side of the heat pump may comprise an expansion valve for expanding the working fluid.

There may be two input conduits to the first side of the heat pump 507. These are a first compressor side input conduit 501 and a second compressor side input conduit 409. The first compressor side input conduit 501 is arranged between the first reactor system 101 and an input conduit of the first side of the heat pump 507. The second compressor side input conduit 409 is arranged between the first heat exchanger 407 and an input conduit of the first side of the heat pump 507. The second compressor side input conduit 409 is equivalent to the output conduit 409 of the first heat exchanger 407 as described earlier for the second embodiment. Within the first side of the heat pump 507, the fluid flows from the first compressor side input conduit 501 and second compressor side input conduit 409 may be combined into a fluid flow, through a single conduit, that is supplied to the compressor. The compressor may be arranged to compress the working fluid. A valve mechanism may control the separate fluid flows into the heat pump 507 from the first compressor side input conduit 501 and the second compressor side input conduit 409.

There may be two output conduits from the second side of the heat pump 507. These are a first expansion side output conduit 502 and a second expansion side output conduit 408. The first expansion side output conduit 502 is arranged between the second side of the heat pump 507 and the cooler 303. The second expansion side output conduit 508 is arranged between the second side of the heat pump 507 and the first heat exchanger 407. The second expansion side output conduit 508 is equivalent to the input conduit 408 of the first heat exchanger 407 as described earlier for the second embodiment. Within the second side of the heat pump 507, there may be a fluid flow, through a single conduit, through the expansion valve that expands the working fluid. In use, the expansion of the working fluid may cool it to a temperature below that required in the first reactor system 101. The cooler 303 may then heat the working fluid, when cooling the sorbent, to an appropriate temperature. The fluid flow may then be split to provide separate working fluid flows into the first expansion side output conduit 502 and a second expansion side output conduit 408. A valve mechanism may control the separate fluid flows into the first expansion side output conduit 502 and a second expansion side output conduit 408.

There may therefore be a flow of working fluid out of the second side of the heat pump 507 into the first expansion side output conduit 502. The working fluid that flows into the first expansion side output conduit 502 may be a cool liquid. The working fluid may then flow through the cooler 303 where it is heated by the sorbent flow through the cooler. The working fluid may then flow through the first reactor system 101 where it is heated. The heating of the working fluid may cause a phase change to occur so that the working fluid that flows out of the first reactor system is a cool gas. The working fluid may flow out of the first reactor system 101 into the first compressor side input conduit 501. The working fluid may flow through the first compressor side input conduit 501 and into the first side of the heat pump 507.

There may also be a flow of working fluid out of the second side of the heat pump 507 into the second expansion side output conduit 408. The working fluid that flows into the second expansion side output conduit 408 may be a cool liquid. The working fluid may then flow through the first heat exchanger 407. The first heat exchanger 407 may be as described earlier for the second embodiment. Accordingly, in the first heat exchanger 407, heat may be exchanged between the output gasses from the second reactor system 102 and the working fluid. This may heat the working fluid so that the working fluid that flows back to the first side of the heat pump 507, via the second compressor side input conduit 409, is a cool gas. The heat exchange between the output gasses from the second reactor system 102 and the working fluid may condense steam in the output gasses to generate water. There may be a water supply conduit 414 for supply the water generated in the first heat exchanger 407 to the second heat exchanger 411.

In the first side of the heat exchanger 507, the received working fluid through the first compressor side input conduit 501 and a second compressor side input conduit 409 may be combined into a single flow of working fluid. The working fluid may then flow through a compressor that compresses the working fluid. The working fluid may then flow into an input conduit 413 of the second heat exchanger 411. The working fluid that flows out of the first side of the heat exchanger may be a hot gas. The working fluid may then flow into the second heat exchanger 411. In the second heat exchanger 411 the working fluid may be arranged to generate steam by heating water that has flowed into the second heat exchanger 411. The water may have been received from the water supply conduit 414, or another water source. The water may also be heated by a flow of sorbent through the second heat exchanger 411. The working fluid may be cooled and this may result in the working fluid undergoing a phase change. The working fluid may therefore change from being a hot gas to a hot liquid. The working fluid may then flow out of the second heat exchanger 411 into an output conduit 412 of the second heat exchanger 411. The working fluid that flows out of the second heat exchanger 411 may be a hot liquid. The working fluid may then flow back to the second side of the heat pump 507. The working fluid may then flow through an expansion valve that expands the working fluid so that it becomes a cool liquid.

Advantageously, the working fluid circulated by the heat pump system may undergo phase changes. Phase change heat transfers may be highly efficient and thereby may maximise heat recovery. The phase changes may also occur at a substantially constant temperature. Phase change heat transfers may be performed with heat exchangers that have a small surface area and this both aids the implementation of the heat exchangers and reduces costs.

As described above, steam may be generated in the second heat exchanger 411. The steam may be supplied to the second reactor system 102 by a first steam supply conduit 509. The second reactor system 102 may also comprise a further steam inlet 204 for receiving steam from other sources. There are a number of advantages arising from mixing steam into the flow of sorbent in the second reactor system 102. These may include increased gas capture and improved operating efficiencies. The vacuum requirement may also be reduced. More specifically, mixing steam into the flow of saturated sorbent reduces the carbon dioxide partial pressure and initiates carbon dioxide desorption. The addition of steam also reduces the need for an extreme vacuum and this improves efficiency. Although not shown in FIG. 3, during operation there may be a heat supply to the sorbent regeneration reaction performed in the second reactor system 102. The heat supply may form any heat source. The heat supply may be excess heat from the process that generates the gas mixture that is input to the first reactor system 101.

According to a fourth embodiment, there is provided a reconfigurable gas capture system that can be changed to be any one of the configurations of gas capture systems of the first embodiment, second embodiment and third embodiment. The gas capture system can be changed to the most appropriate configuration for a specific application or circumstances. The operation of the different heat pump systems and/or heat exchanger systems may be reconfigured for substantially maximising operational efficiencies, such as increasing gas capture and/or reducing the energy required to operate the gas capture system. In particular, the gas capture system may be used to capture gas, such as carbon dioxide, from a combined heat and power (CHP) plant. The gas capture system may use excess energy from the CHP plant, that would otherwise be wasted, to power aspects of its operation.

In particular, the gas capture system may be operated according to a first operating extreme that is the technique described for the first embodiment. This may be appropriate during periods of high energy demand of the CHP plant, such as during the winter months.

The gas capture system may also be reconfigured so that it is operated according to a second operating extreme that is the technique described for the second embodiment. This may be appropriate during periods of low energy demand of the CHP plant, such as during the summer months. When operating at the second operating extreme, the heat supply to the sorbent regeneration reaction performed in the second reactor system 102 may be excess heat from a CHP plant, or other type of power generator. This may avoid the use of a heat pump compressor and/or reduce the size of air cooler. A heat exchanger system may remove heat from the first reactor system 101 and then release the heat to the atmosphere, instead of supplying the heat to the second reactor system 102. When operating at the second operating extreme, the second reactor system 102 may operate substantially at atmospheric pressure. There may therefore only be a temperature difference, and no pressure difference, between the reaction conditions in the first reactor system 101 and second reactor system 102.

The system of the fourth embodiment may also be reconfigured, by a control system, so that it operates between the first and second operating extremes. For example, some, but not all, of the energy that can be transferred from the first reactor system 101 to the second reactor system may be provided to the second reactor system 102. The difference in operating pressures between the first reactor system 101 and the second reactor system 102 may also be varied. Under some of the operating conditions, there may be no difference in operating pressure between the first reactor system 101 and the second reactor system 102. The operating conditions may be dependent on the operation of the CHP plant, or other power source, and, in particular, the amount of waste energy received by the gas capture system from the CHP plant. The operating conditions may also be dependent on the output power of the CHP plant, which is typically varied to match the power demand.

Embodiments include a number of modifications and variations to the above-described techniques.

In all of the above-described embodiments, the pumps, heaters, control system and other components may be powered by electricity. Advantageously, the gas capture system of embodiments may be easily retrofitted to an existing system without being heat integrated into the system.

The sorbent may be a low temperature, medium temperature or a high temperature liquid sorbent. The heat pump that is used should be efficient at the operational temperatures of the gas capture system. Any of a number of known heat pumps may be used. When the operational temperatures throughout the gas capture system are in the range of about 40° C. to 80° C., a commercially available ammonia heat pump may be used. Steam, ethane and/or butane based heat pumps may be more appropriate at the higher operational temperatures. The sorbent changes between a used form and a regenerated form as it is recirculated, in a sorbent cycle, through the components of the gas capture system. The term sorbent as used herein refers generally to liquid sorbent at any point in the sorbent cycle and may refer to the sorbent when it is in either its used form or regenerated form. In addition, the sorbent at any point in the sorbent cycle may always be a mixture of sorbent in the used form and in the regenerated form. The gas capture process in the first reactor system 101 and sorbent regeneration process in the second reactor system 102 may change the proportions of the used and regenerated forms of the sorbent throughout the sorbent cycle.

Embodiments include the use of a mixture of different sorbents so that more than one gas is captured by the gas capture system. For example, different liquid sorbents for respectively capturing carbon dioxide and hydrogen sulphide could be mixed and then used together. The gas capture system would then be capable of capturing both carbon dioxide and hydrogen sulphide from a gas stream.

In a preferred application of embodiments, the gas being cleaned is a flue gas from a combustion process. However, embodiments may be used to capture a gas from any gas mixture and are not restricted to being used for cleaning a flue gas. The gas to be cleaned may be referred to as a dirty gas. The dirty gas may be, for example, sour gas directly output from a well head. The sour gas would be cleaned by capturing the hydrogen sulphide content. Embodiments also include cleaning gasses in industries such as the power generation industry, the metal production industry, cement production industry, fertiliser industry, petrochemical industry, biofuel production and mineral processing industry. In particular, embodiments can be used to clean gasses from cement production processes, blast furnace processes, steel production processes and reforming processes (e.g. for hydrogen production).

All of the components of the gas capture system of embodiments are scalable such that implementations of embodiments are appropriate for small, medium and large industrial scale processes. For example, implementations of embodiments may be used to clean flue gas from small to medium scale engines. Larger implementations of embodiments may be used to clean flue gas from a power plant/station.

Another preferred application of embodiments is in a hydrogen production process. It is known for hydrogen to be produced by sorption-enhanced reforming, SER, and/or by a water gas shift process. These processes may convert methane and steam to a gas mixture comprising hydrogen and carbon dioxide. Embodiments improve on known techniques for separating the generated hydrogen and carbon dioxide in order to obtain substantially pure hydrogen.

In embodiments, steam is fed into the second reactor system 102 with the sorbent. The steam may be generated by any available components with suitable heat. For example, heat from compressor(s) and/or vacuum pump(s) in the gas capture system may be used to heat water to generate the steam. The steam may additionally, or alternatively, be generated from excess heat in the system that generates the gas mixture, for example flue gas, that is received and cleaned by the first reactor system 101.

Embodiments also include alternatively, or additionally, feeding other gasses than steam into the second reactor system 102 to reduce the partial pressure of the released gas therein.

In the fourth embodiment, the gas capture system is described as operating with a CHP plant. Embodiments include the gas capture system operating with other types of power plant than a CHP plant.

As described for the first embodiment, there may be a water based heat exchanger that comprises the fluid inlet 314 and fluid outlet 315 as well as a fluid conduit arranged between the fluid inlet 314 and fluid outlet 315. In the water driven heat exchanger, water, that is at a temperature below that of the heat pump working fluid, is used at an upper stage of the first reactor system 101 to further cool the sorbent and/or reaction conditions. This may reduce the equilibrium carbon dioxide partial pressure and ensure maximum carbon dioxide removal from the flue gas. The heat recovery can be used for low pressure steam generation. The steam may be fed into the second reactor system 102 as described above. The same, or a similar, water based heat exchanger may be used on both the second and third embodiments.

In the second reactor system in all embodiments, the sorbent preferably exits the second reactor system 102 at the location in the second reactor system 102 that has the lowest partial pressure of released gas, e.g. carbon dioxide. If a lot of steam is available and fed into the second reactor system, the rich sorbent may therefore be fed into the second reactor system 102 at the top. However, if only a little steam is available, the hydrostatic pressure in the second reactor system 102 may outweigh the partial pressure reduction from the steam, and the sorbent may therefore exit at the top where the pressure is lowest. Accordingly, the locations of sorbent entry to, and exit from, the second reactor system 102 may depend on the amount of steam that is fed into the second reactor system, and/or other reaction conditions.

In embodiments, generally, the liquid sorbent may comprise a sorbent from the known families: i) chemisorption (e.g., amine-based, ammonia-based, salt solutions); ii) physisorption based (e.g., Glycol-, Carbonate-, methanol- and Glycerol-based); iii) hybrid phys-chemical solvents such as Ionic Liquids; iv) a mixture of i) to iii).

The sorbent may comprise any of the sorbents as disclosed in N. Borhani, T. and M. Wang (2019). “Role of solvents in CO2 capture processes: The review of selection and design methods.” Renewable and Sustainable Energy Reviews 114: 109299; Jang, G. G., J. A. Thompson, X. Sun and C. Tsouris (2021). “Process intensification of CO2 capture by low-aqueous solvent.” Chemical Engineering Journal 426: 131240; and Lail, M., J. Tanthana and L. Coleman (2014). “Non-Aqueous Solvent (NAS) CO2 Capture Process.” Energy Procedia 63: 580-594.

In the first embodiment, a water free liquid sorbent is preferably used (such as low or non-aqueous).

In the second embodiment, a liquid sorbent with a low reaction enthalpy is preferably used mainly physisorption-based.

In the third embodiment, a liquid sorbent that is a water based monoethanolamine, MEA, solvent is preferably used.

In all embodiments, in the first reactor system 101 the operating pressure may be about atmospheric pressure. However, embodiments include the use of higher pressures. For example, the pressure may be 20 bar.

In all embodiments, in the first reactor system 101 the operating temperature may be about 30° C. to 95° C., and preferably about 40° C. to 90° C.

In all embodiments, in the second reactor system 102 the operating pressure may be about 0.01 to 0.8 bar, and preferably 0.1 to 0.5 bar. However, embodiments include the use of lower and higher pressures. For example, the pressure may be 1 bar.

In all embodiments, in the second reactor system 102 the operating temperature may be about 40° C. to 150° C., and preferably about 60° C. to 130° C.

Embodiments include the sorbent pump 202 being located anywhere in the sorbent flow path. For example, the sorbent pump 202 may be located in the first sorbent transfer system.

In the second and third embodiments, the second heat exchanger 411 may arranged to generate steam at a low pressure. Advantageously, the steam may then be generated at a temperature lower that 100° C.

Embodiments also include other configurations of the gas capture system. For example, the working fluid may extract heat from the first reactor system 101 and supply it to the both the second reactor system, as described for the first embodiment, and the second heat exchanger 411, as described for the third embodiment.

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1. A gas capture system comprising:
a first reactor system arranged so that, in the first reactor system, at least some gas in a gas stream that is received by the gas capture system is captured by a sorbent that is arranged to flow through the first reactor system;
a second reactor system arranged to regenerate the sorbent so that the sorbent releases at least some of the gas captured in the first reactor system, wherein the sorbent is arranged to flow through the second reactor system and the second reactor system is arranged to output a gas flow that comprises the released gas;
a first sorbent transfer system arranged between a sorbent outlet of the first reactor system and a sorbent inlet of the second reactor system;
a second sorbent transfer system arranged between a sorbent outlet of the second reactor system and a sorbent inlet of the first reactor system; and
a heat pump system comprising a heat pump arranged to circulate a flow of working fluid, wherein the heat pump system is arranged to extract heat from the first reactor system and/or the gas flow output from the second reactor system;
wherein:
the sorbent is a liquid;
the second reactor system comprises a pump arranged to reduce the pressure in the second reactor system so that the pressure in the second reactor system when regenerating sorbent may be lower than the pressure in the first reactor system during gas capture by the sorbent; and
the first reactor system, first sorbent transfer system, second reactor system and second sorbent transfer system are all arranged so that they provide a sorbent flow path that recirculates the sorbent between the first reactor system and the second reactor system.

2. The gas capture system according to claim 1, wherein the gas capture system further comprises:
a gas inlet arranged to receive the gas stream;
a first gas outlet arranged to output the gas stream that has flowed through the first reactor system; and
a second gas outlet arranged to output the gas flow from the second reactor system.

3. The gas capture system according to claim 1, wherein, in use, the operating temperature of the second reactor system when the sorbent is regenerated is higher than the operating temperature of the first reactor system when the gas is captured.

4. The gas capture system according to claim 1, wherein the first reactor system is configured to react sorbent with the gas stream at an operational temperature in a range of about 30° C. to 95° C., and preferably about 40° C. to 90° C.

5. The gas capture system according to claim 1, wherein the second reactor system is configured to regenerate sorbent at an operational temperature in a range of about 40° C. to 150° C., and preferably about 60° C. to 130° C.

6. The gas capture system according to claim 1, wherein, in use, the operating pressure of the second reactor system is in a range of about 0.001 bar to 1.2 bar, and preferably 0.01 bar to 0.8 bar, and more preferably 0.1 to 0.5 bar.

7. The gas capture system according to claim 1, wherein, in use, the operating pressure of the first reactor system is in a range of about 0.9 bar to 20 bar, and preferably about 1 bar.

8. The gas capture system according to claim 1, wherein the sorbent comprises monoethanolamine, MEA.

9. The gas capture system according to claim 1, wherein the received gas stream by the gas capture system comprises carbon dioxide; and
wherein the gas captured by the sorbent is carbon dioxide.

10. The gas capture system according to claim 1, wherein the gas captured by the sorbent is one or more of hydrogen sulphide, SOx, hydrogen and NOx.

11. The gas capture system according to claim 1, wherein the received gas stream by the gas capture system is a flue gas or a gas mixture generated by a reforming process.

12. The gas capture system according to claim 1, further comprising a steam inlet arranged to receive a flow of steam so that steam may be injected into second reactor system.

13. The gas capture system according to claim 1, further comprising a water based heat exchanger arranged to use heat in the first reactor system to generate steam.

14. The gas capture system according to claim 1, further comprising a steam inlet arranged to receive a flow of steam so that steam may be injected into second reactor system;
further comprising a water based heat exchanger arranged to use heat in the first reactor system to generate steam;
wherein the water based heat exchanger is arranged to supply steam to the steam inlet.

15. The gas capture system according to claim 1, further comprising a cooler arranged in the sorbent flow path in the second sorbent transfer system;
wherein the cooler is arranged to cool the sorbent by transferring heat between the sorbent and the working fluid.

16. The gas capture system according to claim 1, further comprising:
a steam inlet arranged to receive a flow of steam so that steam may be injected into second reactor system; and
a first heat exchanger and a second heat exchanger;
wherein:
the gas flow output from the second reactor system is arranged to flow through the first heat exchanger;
the second heat exchanger is arranged to receive a flow of water;
the heat pump system is arranged to circulate the working fluid between the first heat exchanger, the heat pump and the second heat exchanger to thereby transfer heat from the first heat exchanger to the second heat exchanger;
the second heat exchanger is arranged to generate steam by heating the received flow of water using at least some of the heat received from the working fluid;
the second heat exchanger is arranged to supply steam to the steam inlet;
the first heat exchanger is arranged to generate water by condensing steam in the gas flow output from the second reactor system and to supply the water to the second heat exchanger;
the heat pump system is arranged to circulate the working fluid between a heat exchanger in the first reactor system and the second heat exchanger so as to transfer heat from the first reactor system to the second heat exchanger; and
the second heat exchanger is arranged to generate steam at a low pressure so that the steam is generated at a temperature lower than 100° C.

17.-20. (canceled)

21. The gas capture system according to claim 1, wherein the heat pump system is arranged to circulate the working fluid between a heat exchanger in the first reactor system and a heat exchanger in the second reactor system so as to transfer heat between the first reactor system and the second reactor system;
wherein the second reactor system is arranged to regenerate the sorbent by heating the sorbent with heat received from at least the working fluid.

22. The gas capture system according to claim 1, wherein the heat pump system is configured so that, in use, the working fluid undergoes phase changes when recirculated around the heat pump system.

23. The gas capture system according to claim 1, further comprising a control system for controlling:
the operating temperature and/or pressure of the first reactor system;
the operating temperature and/or pressure of the second reactor system;
the generation and injection of steam into the second reactor system;
the configuration and/or operation of the heat pump system; and/or
the configuration and/or operation of the gas capture system.

24. The gas capture system according to claim 1, further comprising:
a steam inlet arranged to receive a flow of steam so that steam may be injected into second reactor system; and
a first heat exchanger and a second heat exchanger;
wherein:
the gas flow output from the second reactor system is arranged to flow through the first heat exchanger;
the second heat exchanger is arranged to receive a flow of water;
the heat pump system is arranged to circulate the working fluid between the first heat exchanger, the heat pump and the second heat exchanger to thereby transfer heat from the first heat exchanger to the second heat exchanger;
the second heat exchanger is arranged to generate steam by heating the received flow of water using at least some of the heat received from the working fluid;
the heat pump system is arranged to circulate the working fluid between a heat exchanger in the first reactor system and a heat exchanger in the second reactor system so as to transfer heat between the first reactor system and the second reactor system; and the second reactor system is arranged to regenerate the sorbent by heating the sorbent with heat received from at least the working fluid;
the gas capture system further comprising a control system for controlling:
the operating temperature and/or pressure of the first reactor system;
the operating temperature and/or pressure of the second reactor system;
the generation and injection of steam into the second reactor system;
the configuration and/or operation of the heat pump system; and/or
the configuration and/or operation of the gas capture system;
wherein the control system is arranged to:
vary the heat transfer from the first reactor system to the second reactor system by the heat pump system;
vary the heat transfer from the first heat exchanger to the second heat exchanger by the heat pump system;
vary the heat transfer from the first reactor system to the second heat exchanger by the heat pump system; and
vary the generation and injection of steam into the second reactor system;
wherein the control system is arranged to control the operation and/or configuration of the gas capture system in dependence on one or more of: a target amount of gas capture, the cost of operating the gas capture system, a target efficiency of the gas capture system, the operation of source of the gas stream that is received by the gas capture system, and the energy supply requirement of the source of the gas stream that is received by the gas capture system.

25. (canceled)
